(19) United States
(12) Patent Application Publication
(10) Pub. No.: US 2007/0282476 A1
(43) Pub. Date: Dec. 6, 2007

(54) Dynamic Workflow Scheduling

(75) Inventors: Xiping Song, Cranbury, NJ (US); Minmin Han, Seattle, WA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC, PRINCETON, NJ (US)

(21) Appl. No.: 11/750,675

(22) Filed: May 18, 2007

Related U.S. Application Data
(60) Provisional application No. 60/804,040, filed on Jun. 6, 2006.

(51) Int. Cl. G06F 19/00; G05B 19/418

(52) U.S. Cl. 700/100; 700/103; 705/8

(57) ABSTRACT

Methods and apparatus are disclosed for workflow scheduling. A workflow scheduling system, such as a computer system, is used to coordinate and schedule tasks in complex scheduling environments. The system accepts incoming orders and dynamically schedules them according to the constraints of the resources required for the order and any constraints of the orders themselves.

This application claims the benefit of U.S. Provisional Patent Application Ser. No. 60/804,040, filed Jun. 6, 2006, entitled “Dynamic Medical Workflow Scheduling In A Distributed Healthcare Environment,” the content of which is hereby incorporated herein by reference in its entirety for all purposes.

### FIELD OF THE INVENTION

The present invention relates generally to workflow scheduling, and more particularly to medical workflows in a distributed healthcare environment.

### BACKGROUND OF THE INVENTION

Workflow scheduling is generally approached as a Constraint Classification Problem (CSP) where a set of variables and the possible values of the variables as well as a set of constraints define the CSP. Solutions to CSPs are assignments of the variables such that all of the constraints are satisfied. Algorithms used in solving CSPs include backtracking, iterative improvement, and propagating constraints. These algorithms are enhanced using heuristic and/or domain knowledge.

When knowledge of the variables and the constraints is scattered across multiple agents, specialized CSP algorithms (e.g., distributed CSP algorithms) are used. When uncertainty (e.g., changing constraints dynamically) is introduced into workflow scheduling in these situations, other algorithms, such as dynamic CSP algorithms, are used to satisfy the CSP.

Workflow scheduling in intricate environments, such as a medical or healthcare environment, is difficult because of the complexity of coordinating multiple resources (e.g., machines, personnel, etc.) with procedure timelines (e.g., the amount of time a procedure takes, the time of day a procedure must be performed, etc.). In many scheduling environments, multiple departments and urgencies also have an impact on the scheduling process.

For example, in the healthcare environment, a doctor orders one or more procedures (e.g., tests, exams, etc.) for multiple patients. The procedures may require the use of physical resources, such as an X-Ray machine or a Magnetic Resonance Imaging (MRI) machine, as welt as personnel resources, such as a laboratory technician, a phlebotomist, or a nurse. Some procedures for the same patient require a certain timeline or sequencing, such as to be performed in the morning before a meal, to be performed before or after another test, or to be performed in two stages thirty minutes apart, etc. Further, in the healthcare environment, emergency situations (e.g., with the same patient or with a new patient entering the environment) often require rescheduling, postponing, and/or superseding previously scheduled procedures. One alteration to a schedule may cause a chain effect that requires multiple changes to other schedules, resources, and procedures. In such a dynamic environment, lack of control over scheduling can be chaotic and highly inefficient.

Current methods of scheduling in intricate environments require resource managers (e.g., nurses, shift supervisors, etc.) to use multiple schedulers, both on- and off-line, and rely on local knowledge (e.g., human knowledge, procedure information tables, etc.) to schedule workflow. In the example of the healthcare environment, a nurse may be required to rely on personal knowledge of procedure sequence, call or access (e.g., using a computer program) the schedules of multiple departments to request available schedule slots, and attempt to fit the procedure sequence into the available slots without the ability to dynamically alter the other scheduled procedures to provide a more efficient workflow.

Additionally, the current methods fail to adequately address the issue of uncertainty. Again, in the healthcare environment, uncertainty is introduced into the system by the appearance of patients in emergency situations and/or changes to a current patient's condition, which may require different procedures, moving the patient into a higher priority classification for the current procedures, or rescheduling of multiple procedures.

Therefore, alternative systems and methods are required to integrate scheduling and provide timely, efficient, and centralized scheduling of workflow.

### SUMMARY OF THE INVENTION

The present invention provides improved methods and apparatus for workflow scheduling. The methods of scheduling use a computer system to receive one or more work orders, determine scheduling constraints for fulfilling the orders, determine availability of one or more resources for fulfilling the orders, and schedule the one or more orders based on the scheduling constraints and the availability of the one or more resources. The orders are retrieved from a memory and the scheduling constraints are stored and retrieved from a knowledge base. The knowledge base has at least one of a temporal constraint list, a resource constraint list, a medical constraint list, a timing list, and a workflow template. The scheduling system uses a CSP algorithm, such as a backtracking search algorithm to determine a schedule. After the schedule is determined, the resources are reserved and schedules are generated for each of the orders and the resources. In one or more embodiments, multiple possible schedules are determined and one or more parameters of the schedules are ranked.

These and other advantages of the invention will be apparent to those of ordinary skill in the art by reference to the following detailed description and the accompanying drawings.

### BRIEF DESCRIPTION OF THE DRAWINGS

FIG. 1 depicts a physician order entry interface according to one embodiment of the present invention;

FIG. 2 illustrates a workflow scheduling system according to an embodiment of the present invention;

FIG. 3 depicts a flowchart of a method for workflow scheduling according to an embodiment of the present invention;

FIG. 4 illustrates an exemplary generated schedule according to one embodiment of the present invention;

FIG. 5 illustrates an exemplary generated schedule according to one embodiment of the present invention;

FIG. 6 illustrates an exemplary generated schedule according to one embodiment of the present invention; and

FIG. 7 illustrates an exemplary generated schedule according to one embodiment of the present invention.

### DETAILED DESCRIPTION

The present invention generally provides methods and apparatus for workflow scheduling. A workflow scheduling system, such as a computer system, is used to coordinate and schedule tasks in complex scheduling environments. The system accepts incoming orders and dynamically schedules them according to the constraints of the resources required for the order and any constraints of the orders themselves. Orders may be any variable input into the scheduling system for which the scheduling system seeks a schedule and/or optimized result. Herein, a procedure may be an order or part of an order and may be considered to be a variable in CSPs. Constraints may be any condition that a solution to the scheduling problem attempts to satisfy. Resources may be a type of item (e.g., human, equipment, etc.) used in accomplishing orders.

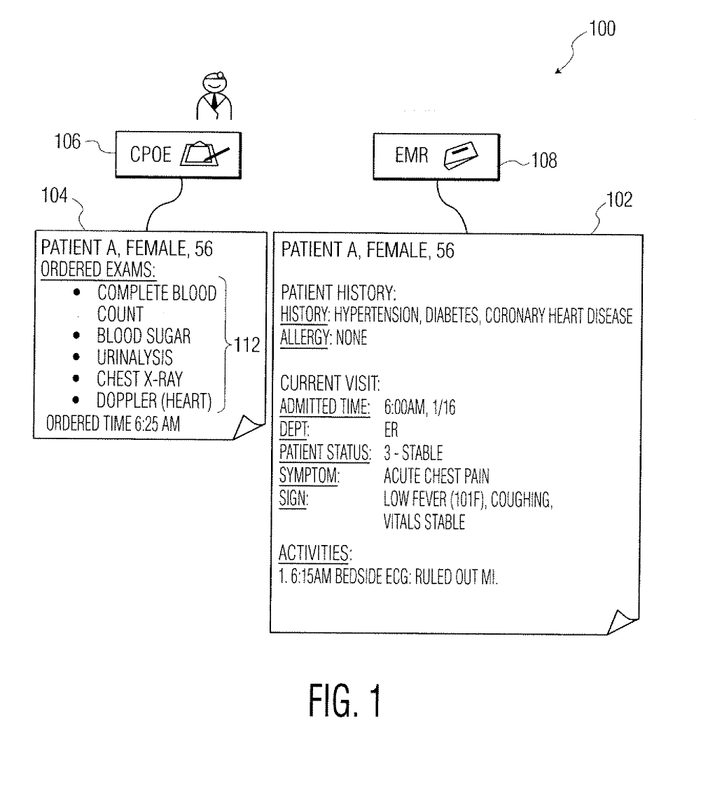

Various embodiments related to medical workflow scheduling are presented in FIGS. 1-7. It may be understood that, though presented herein as an exemplary healthcare workflow scheduling system, the present invention may be applied to other scheduling environments, such as legal, shipping and receiving, manufacturing, etc.

FIG. 1 depicts a physician order entry interface 100 according to one embodiment of the present invention. The order entry interface 100 may have one or more medical records 102 for one or more patients and may allow an order 104 to be entered.

The order entry interface 100 may be a component of a Computerized Physician Order Entry (CPOE) system 106 or another similar system. Similarly, the medical records 102 may be a part of the CPOE system 106 or an Electronic Medical Record (EMR) system 108. In some embodiments, the EMR system 108 may be a component of the CPOE system 106 or another similar system.

A medical record 102 may include relevant information, such as allergies, patient history, admission details, symptoms, care received, and workflow scheduled and/or completed. Such information may be entered into the medical record 102 and/or the EMR system 108 by a healthcare provider 110 (e.g., a doctor or nurse).

An order 104 may include one or more procedures 112. Procedures 112 may be entered by the healthcare provider 110 into the order 104, the CPOE system 106, and/or with any other appropriate method of order entry. Procedures 112 may be any test, exam, or procedure to be performed by, on, or for a patient. Exemplary procedures include blood counts, blood sugar tests, urinalysis, chest X-Ray, Doppler, surgery, specialist consultation, drug dosing, etc.

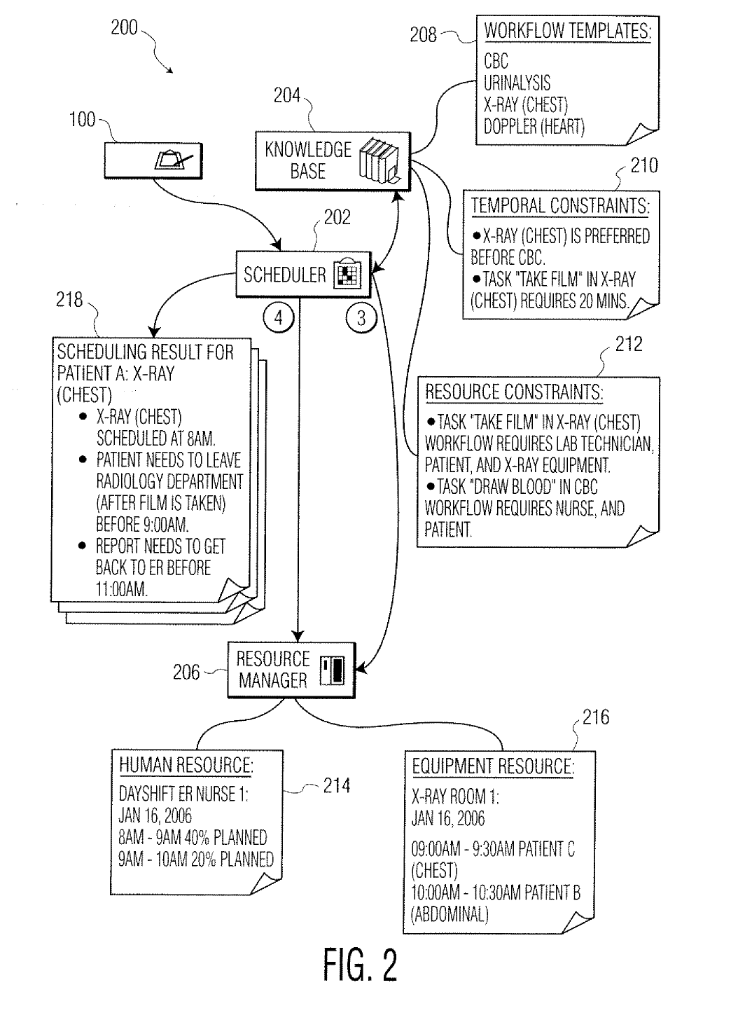

FIG. 2 illustrates a workflow scheduling system 200 according to an embodiment of the present invention. The workflow scheduling system 200 comprises order entry interface 100 that sends orders to a scheduler 202. The scheduler 202 receives information from and sends information to the knowledge base 204 and the resource manager 206. In some embodiments, one or more of the order entry interface 100, the CPOE system 106, the scheduler 202, the knowledge base 204, and/or the resource manager 206 may be incorporated and/or combined into one or more computer programs or interfaces.

In some embodiments, one or more of the order entry interface 100, the scheduler 202, the knowledge base 204, and/or the resource manager 206 may be implemented on and/or may include any components or devices that are typically used by, or used in connection with, a computer, software, or computer system. Although not explicitly pictured in FIGS. 1 and 2, the order entry interface 100, the scheduler 202, the knowledge base 204, and/or the resource manager 206 may include one or more central processing units, read only memory (ROM) devices and/or random access memory (RAM) devices. The order entry interface 100, the scheduler 202, the knowledge base 204, and/or the resource manager 206 may also include one or more databases for storing any appropriate data and/or information such as order information, constraints (discussed below), and schedules, one or more programs or sets of instructions for executing methods of the present invention, and/or any other computer components or systems, including any peripheral devices.

According to some embodiments of the present invention, instructions of a program (e.g., controller software) may be read into a memory of the order entry interface 100, the scheduler 202, the knowledge base 204, and/or the resource manager 206 from another medium, such as from a ROM device to a RAM device or from a LAN adapter to a RAM device. Execution of sequences of the instructions in the program may cause the order entry interface 100, the scheduler 202, the knowledge base 204, and/or the resource manager 206 to perform one or more of the method steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory may store the software for the controller, which may be adapted to execute the software program and thereby operate in accordance with the present invention and particularly in accordance with the methods described in detail below. However, it would be understood by one of ordinary skill in the art that the invention as described herein could be implemented in many different ways using a wide range of programming techniques as well as general purpose hardware sub-systems or dedicated controllers.

The program may be stored in a compressed, uncompiled and/or encrypted format. The program furthermore may include program elements that may be generally useful, such as an operating system, a database management system and device drivers for allowing the controller to interface with computer peripheral devices and other equipment/components. Appropriate general purpose program elements are known to those skilled in the art, and need not be described in detail herein.

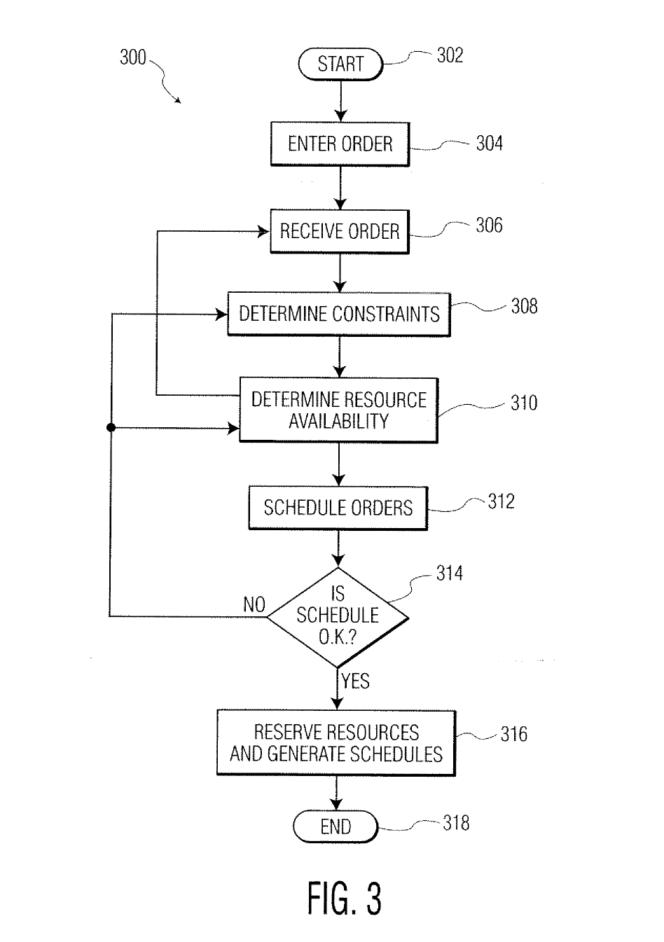

Scheduler 202 may be any appropriate computer program or interface capable of performing scheduling functions. In accordance with known scheduling methods (e.g., CSP methods, etc.), the scheduler may utilize information from one or more of the order entry interface 100, the CPOE system 106, the knowledge base 204, and/or the resource manager 206 to schedule one or more procedures. Specific scheduling steps will be discussed further below with respect to FIG. 3 and the method 300.

Knowledge base 204 may be a database, computer program, or other data source and may comprise one or more scheduling constraint lists, such as workflow template list 208, temporal constraint list 210, and/or resource constraint list 212. Other systems, databases, and methods may be used to store one or more constraints at the knowledge base 204. Similarly, other constraints and/or constraint lists (e.g., medical constraint lists, timing lists, etc.) may be stored at and/or be accessible by the knowledge base 204. Further, the knowledge base 204 may contain procedures tasks, expected performance time for procedures, deadlines, start and end times for procedures, priorities, and other constraints related to scheduling procedures.

Workflow template list 208 may contain information about a procedure, such as a sub-procedure comprising other procedures, tasks, or a direction to an entry in the temporal constraint list 210 or the resource constraint list 212. The workflow template list may also contain information about a procedure related to additional constraints or concerns, a priority (e.g., preference) ranking for procedures' constraints, or any other appropriate information.

Temporal constraint list 210 may contain information about the timings required for a procedure. These timings may include start and/or end times for a procedure, the time required to complete a procedure, a timing relative to another task or procedure (e.g., a procedure must be completed before a first meal, etc.), or any other related timings. For example, the temporal constraint list 210 may have an entry indicating that a chest X-Ray should be performed before a Complete Blood Count (CBC). Such an entry may have an associated preference or ranking. That is, the temporal constraint list 210, the workflow template list 208, or another portion of the knowledge base 204 may indicate that performing the chest X-Ray before the CBC is strongly preferred, but the order may be reversed if no schedule can be constructed with the procedures in that order. Another entry on the temporal constraint list may indicate the amount of time required and/or budgeted for a procedure. For example, the resource constraint list 210 may contain an entry indicating that a chest X-Ray takes twenty minutes to complete. For scheduling flexibility, the entry may further indicate that, in some scheduling situations, the chest X-Ray time may be reduced to fifteen minutes, though there may be a strong preference indicator against this temporal adjustment. Other related temporal constraints for procedures and/or personnel (e.g., breaks, etc.) may be included as one or more accessible entries in the temporal constraint list 210.

Resource constraint list 212 may contain information about resources required or preferred for a procedure. For example, the resource constraint list 212 may have an entry indicating that a chest X-Ray requires three resources: a lab technician, the patient, and an X-Ray machine. A further exemplary entry in the resource constraint list may indicate that a subroutine of drawing blood in the procedure CBC requires two resources, with one resource being flexible in assignment—the first resource being the patient and the second resource being a nurse or a phlebotomist. Other resource constraints for procedures may be included as one or more accessible entries in the resource constraint list 212.

Resource manager 206 may be a database, computer program, or other data source and may comprise one or more resource constraint lists like human resource constraint list 214 and equipment resource constraint list 216. The resource manager 206, by way of human resource constraint list 214 and equipment resource constraint list 216, may track and/or schedule one or more resources. As described above, resources may be any personnel, space, and/or equipment required for any procedure.

Human resource constraint list 214 may have a listing of all available personnel within one or more categories (e.g., nurses, laboratory technicians, phlebotomists, surgeons, etc.) as well as their respective availabilities and/or schedules. In this way, the resource manager 206 may track and/or schedule the personnel. The human resource constraint list 214 may contain information about scheduled procedures as well as other activities (e.g., breaks, rounds, etc.) which fill a human resource's time. For example, human resource constraint list 214 may contain an entry indicating that, on January 16, Dayshift Nurse #1 has 24 minutes of activity scheduled between 8 AM and 9 AM, but only 12 minutes of activity scheduled between 9 AM and 10 AM.

Similarly, the equipment resource constraint list 216 may have a listing of all available equipment within one or more categories (e.g., X-Ray machines, laboratories, MRI machines, patient rooms, etc.) as well as their respective availabilities and/or schedules. In this way, the resource manager 206 may track and/or schedule the equipment. For example, on January 16, X-Ray Room #1 may be booked at 9 AM for thirty minutes and again at 10 AM for thirty minutes. It should be noted that resource constraints such as those in the knowledge base 204 may indicate a preference for scheduling one or more resources for longer than the required procedure time. In the example above, the chest X-Ray required thirty minutes, but X-Ray Room #1 may be booked at 9 AM for thirty minutes in the equipment resource constraint list 216 for reasons apparent to one of skill in the art. Other appropriate differences between information in the knowledge base 204 and the resource manager 206 may be tolerable and/or preferable in some scheduling environments.

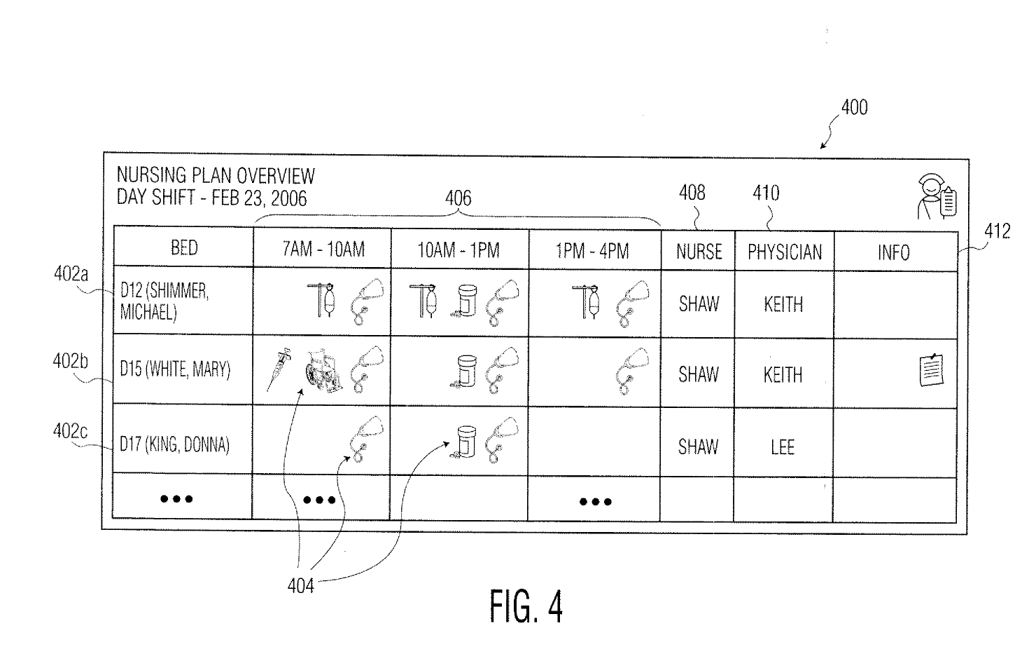

The workflow scheduling system 200 may produce one or more schedules 218. Schedules 218 may provide a global and/or local schedule, as appropriate and may tabulate and/or display the schedules in any appropriate manner. That is, the schedules 218 may be schedules for each human resource, all human resources, each patient, all equipment, etc. Exemplary schedules are included below with respect to FIGS. 4-7.

In operation, the components of FIGS. 1 and 2 may be used for workflow scheduling. FIG. 3 depicts a method 300 for workflow scheduling using a computer system according to an embodiment of the present invention. For illustrative purposes, a healthcare environment is assumed for scheduling and an exemplary medical procedure is scheduled. The method starts at step 302.

In step 304, an order is entered into the order entry interface 100. As discussed above with respect to FIG. 1, an order 104 may be one or more procedures 112 for a patient (e.g., Patient A) and is entered by healthcare provider 110 (e.g., the attending physician) using the CPOE system 106 based on an examination and the patient medical record 102. One or more orders 104 may be stored (e.g., in a memory) at the order entry interface 100 and/or the CPOE system 106. In the illustrative example of FIGS. 1-3, healthcare provider 110 orders five procedures 112 for Patient A—a CBC, a blood sugar test, a urinalysis, a chest X-Ray, and a heart Doppler.

In step 306, the order 104 is received at the scheduler 202. The scheduler 202 may receive more than one order for one or more patients simultaneously (e.g., in batches) and/or continuously (e.g., as orders are entered in the order entry interface 100). In at least one embodiment, the order 104 is retrieved from a memory of order entry interface 100 by the scheduler 202.

In step 308, scheduling constraints for fulfilling the order 104 are determined. To determine the scheduling constraints, the scheduler 202 may query (e.g. access, retrieve information from, etc.) the knowledge base 204 for constraints related to the order 104. These constraints may be retrieved from one or more of the scheduling constraint lists.

Based on the procedures 112 in the order 104, the scheduler 202 may determine from the knowledge base 204 and the workflow template list 208 that the ordered urinalysis is a lower priority than the ordered CBC and chest X-Ray. The scheduler 202 may determine from the temporal constraints list 210 that the chest X-Ray is preferred before the CBC and takes twenty minutes. The scheduler 202 may also determine from the resource constraint list 212 that the chest X-Ray requires both equipment and personnel resources while the CBC only requires personnel resources. Of course, any number of scheduling constraints may be determined in this manner. For example, the scheduler 202 may determine from the knowledge base 204 a global constraint related to staffing and competence levels that supersedes all other constraints.

In step 310, the availability of one or more resources are determined. The scheduler 202 may query the resource manager 206 to determine which resources are currently scheduled and/or unavailable as well as the priorities (e.g., importance) of the current appointments and any openings in a schedule of the resource. For example, the scheduler 202 may determine from the human resource constraint list 214 that Dayshift Nurse #1 has 24 minutes of activity scheduled between 8 AM and 9 AM and may thus be scheduled for further activity during that time period. Similarly, the scheduler 202 may determine from equipment resource constraint list 216 that X-Ray Room #1 is booked at 9 AM for thirty minutes and is thus available before and after that time.

The method 300 may return control to steps 306 and/or 308 one or more times to receive further orders and determine related constraints and/or the availability of resources. After determining scheduling constraints and the availability of resources for the current orders in steps 206-310, the method proceeds to step 312.

In step 312, the scheduler 202 schedules one or more orders 104 based on the scheduling constraints from step 308 and the availability of one or more resources determined in step 310. To schedule an order 104, the scheduler 202 takes into account the variables (e.g., procedures 112) and the possible values of the variables as well as the set of constraints determined in steps 308 and 310 as a CSP. Solutions to the CSP include one or more possible schedules. The CSP may be solved (e.g., one or more schedules may be determined) using one or more well known algorithms and/or enhanced algorithms. Such algorithms used in solving CSPs (e.g., determining one or more schedules) include backtracking, iterative improvement, and propagating constraints. These algorithms may be enhanced using heuristic and/or domain knowledge. Any other appropriate algorithm and/or method for determining a schedule based on the procedures and the constraints may be used.

If a solution is found, a schedule 218 may be produced. Exemplary schedules are discussed below in more detail with respect to FIGS. 4-7.

Following scheduling in step 312, a check is performed in step 314 to determine if the schedule 218 is acceptable. This check may be necessary if no schedule can be determined in step 312 based on the current constraints. If no schedule or no acceptable schedule is determined in step 312, the method 300 may return control to step 308 and/or step 310 to modify the constraints. That is, the scheduler 202 may re-query the knowledge base 204 and/or the resource manager 206 to determine alternate constraints, priorities, and/or determine the importance of and/or any flexibility in certain constraints.

For example, the knowledge base 204 may have previously indicated that a procedure requires twenty minutes when the actual procedure only requires fifteen minutes with a five minute safety margin included. Also, the knowledge base 204 may provide information indicating that, while the chest X-Ray is preferred before the CBC, it may be performed after it. Additionally, the resource manager 206 may have indicated that a nurse is scheduled for a fifteen minute break during a busy period. If no schedule is determined in step 312, the scheduler 202 may determine from the knowledge base 204 that there are an “extra” five minutes available, that the nurse's break may be rescheduled, and that the X-Ray and CBC may be juxtaposed. The method 300 then proceeds to step 312 again, where the scheduler 202 attempts to schedule the order 104 with this new constraint information.

In some embodiments, when multiple schedules 218 are determined in step 312, the check may be performed to determine the most advantageous schedule. This may be accomplished by ranking one or more parameters of each of the multiple schedules. That is, each schedule 218 may be given a score or other quantitative and/or qualitative determination of the schedule. For example, the schedules may each be ranked based on how hectic they are for the shift nurses, how many procedures must be performed out of preferred order, and/or how many time constraints are adhered to, among other possible ranking factors. The rankings may be measured against one another by the scheduler 202 to determine the most advantageous schedule, or, in some embodiments, each of the schedules and their rankings may be displayed (e.g., at the CPOE system 106) to one or more healthcare providers 110 who may manually determine the preferred schedule.

If no schedule 218 can be determined after multiple iterations, an alert may be issued through the workflow scheduling system 200, the order entry interface 100 and/or any other appropriate interface. In this case, user intervention may be required to alter one or more constraints and/or procedures to allow a feasible schedule to be determined.

Though discussed in this example as scheduling within specific blocks of time (e.g., from 9 AM to 9:30 AM) it may be understood that any other appropriate flexible scheduling may be used. For example “bucket scheduling” may be used in which multiple procedures are scheduled for a “bucket” of time. That is, four procedures, each requiring less than twenty minutes of work with no constraints as to order, may be placed in the bucket of 9 AM to 11 AM. In this way, scheduling is more flexible and dynamic.

After an acceptable schedule has been determined in step 312, the resources are reserved and one or more schedules are generated in step 316. Here, the scheduler 202 reserves the resources at the resource manager 206. This may be accomplished by holding one or more resources as unavailable for a certain period and generating a schedule indicating the same and/or any other appropriate reservation method. Further, the scheduler 202 may generate one or more schedules 218 in a useful form as in FIGS. 4-7 below. Similarly, a generated schedule may be embedded in a patient workflow in the EMR system 108, the CPOE system 104, and/or any other automatic schedule generation. Still further, the generated schedule may be exported to other associated systems and/or simply printed or otherwise outputted for use by a healthcare provider 110. The method ends at step 318.

The method 300 may be re-entered and a new schedule determined at any point. That is, if a new patient with new orders enters the environment, a current patient requires new procedures, an emergency condition develops, or a scheduled activity is over-run or otherwise displaced, a new schedule 218 may be dynamically generated on command based on the new scheduling constraints. For example, if an X-Ray machine fails and a patient must be reschedule for another X-Ray machine 40 minutes later, the cascade effect of this change may be realized and adjusted for by the scheduler 202. The scheduler 202 may accept the new order (e.g., the new X-Ray requirement) and use the new constraints (e.g., X-Ray resource is unavailable and CBC time must be adjusted) to quickly and efficiently change the entire schedule or a portion of the schedule. This provides a flexible scheduling environment that may be adapted quickly from a central location.

FIG. 4 illustrates an exemplary generated schedule 400 according to one embodiment of the present invention. The generated schedule 400 is a nursing plan overview indicating multiple patients 402a-c, procedures 404 that must be performed and the buckets 406 of time in which the procedures 404 must be performed, the nurse 408, physicians 410, and other notes 412. The schedule 400 may be for an entire ward and guide activities throughout the day.

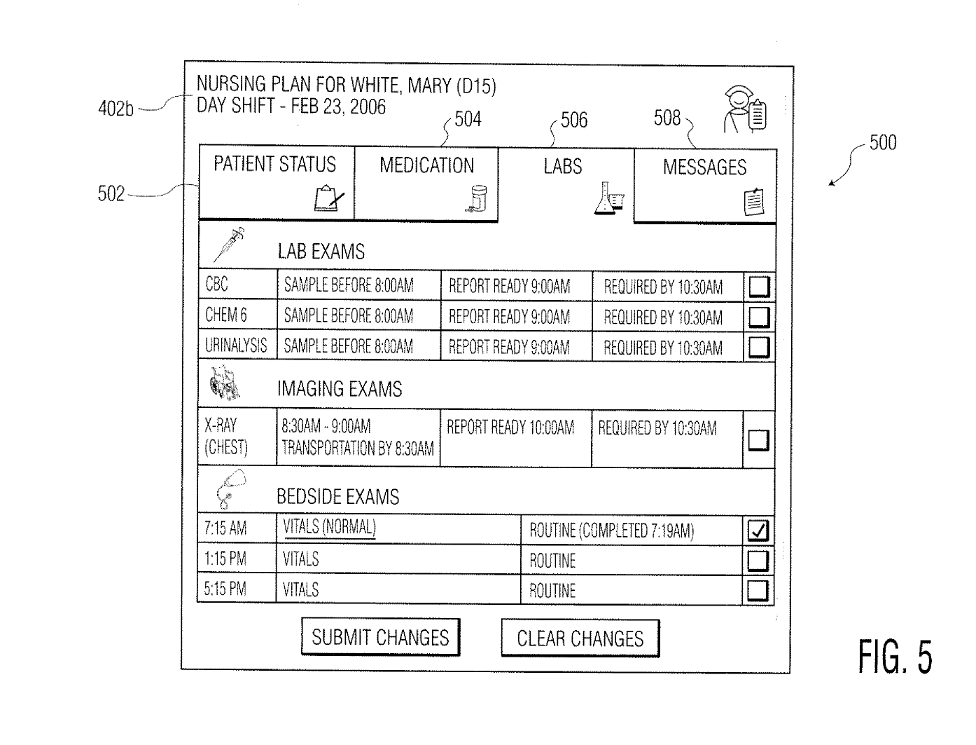

FIG. 5 illustrates an exemplary generated schedule 500 according to one embodiment of the present invention. The schedule 500 is related to schedule 400 in that it is the entire schedule for patient 402b. The schedule 500 may include information such as the patient status 502, the patient's medication schedule 504, the patient's procedures 506, and other messages 508. The schedule 500 may be available to any healthcare provider dealing with patient 402b.

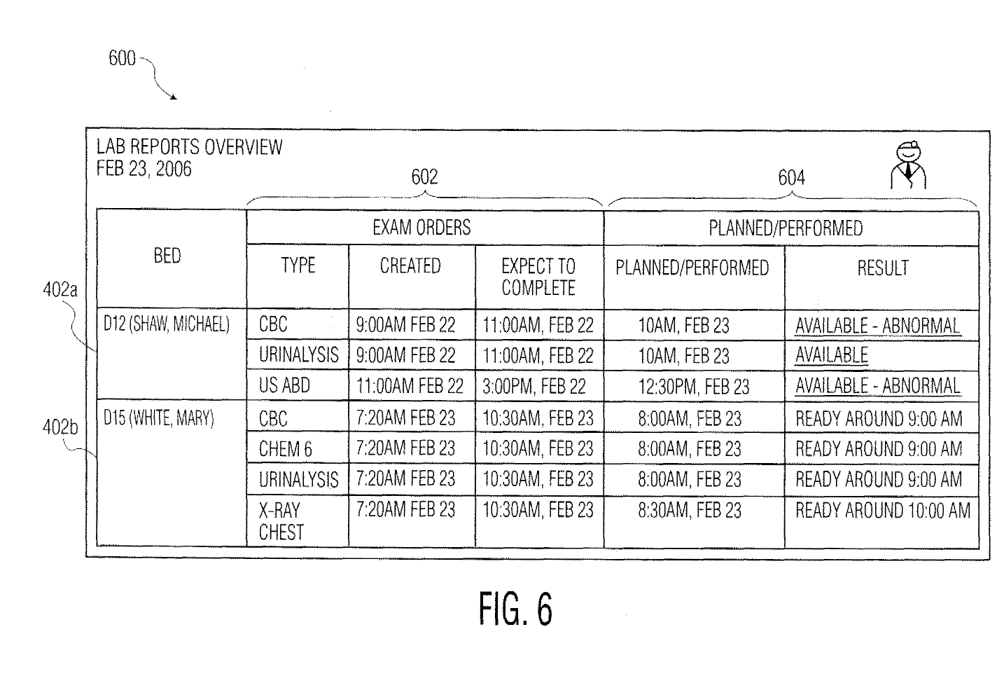

FIG. 6 illustrates an exemplary generated schedule 600 according to one embodiment of the present invention. The schedule 600 is related to schedules 400 and 500 in that it is a procedure schedule for patients 402a-b indicating all scheduled laboratory procedures 602 and results 604. The schedule 600 may be for an entire ward and/or laboratory.

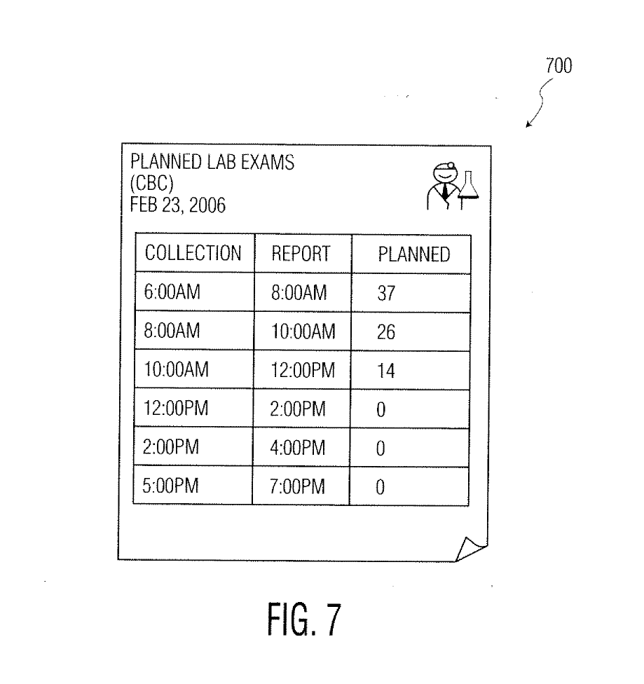

FIG. 7 illustrates an exemplary generated schedule 700 according to one embodiment of the present invention. The schedule 700 is related to schedules 400, 500, and 600 in that it is an aggregate collection of laboratory procedures to be performed. The schedule 700 may be used by a laboratory to schedule procedures.

FIGS. 4-7 illustrate four exemplary schedules that are each a portion of a generated schedule 218 of method 300. Any other appropriate schedules and/or displays may be used to generate and/or provide schedules in accordance with the workflow scheduling system 200 and the workflow scheduling method 300.

The foregoing description discloses only particular embodiments of the invention; modifications of the above disclosed methods and apparatus which fall within the scope of the invention will be readily apparent to those of ordinary skill in the art.

For instance, it will be understood that, though discussed primarily as a medical workflow scheduling system, the method 300 and the system 200 could be applied to other scheduling environments. For example, in a legal docketing environment, constraints may include bar dates, deadlines for response, penalty periods, expected time to prepare certain documents, etc. Resources may include attorneys, legal support staff, copying facilities, etc. Thus an order (e.g., a patent application) may be received at a scheduler. The scheduler may determine the current docket of one or more attorneys, the attorneys' familiarity with the subject matter, vacations, and other constraints. The scheduler may docket the patent application based on the constraints and may re-docket the application when a new order (e.g., an Office Action) is received and given a higher priority. Other scheduling environments such as shipping and manufacturing may use the system and methods of the present invention similarly.

Accordingly, while the present invention has been disclosed in connection with specific embodiments thereof, it should be understood that other embodiments may fall within the spirit and scope of the invention, as defined by the following claims.

What is claimed is:

1. A method of scheduling using a computer system comprising:
receiving one or more orders;
determining scheduling constraints for fulfilling the orders;
determining availability of one or more resources for fulfilling the orders;
scheduling the one or more orders based on the scheduling constraints and the availability of the one or more resources.

2. The method of claim 1 wherein receiving one or more orders comprises retrieving the orders from a memory.

3. The method of claim 1 wherein determining scheduling constraints comprises:
retrieving information from a knowledge base.

4. The method of claim 3 wherein the knowledge base comprises at least one of a temporal constraint list, a resource constraint list, a medical constraint list, a timing list, and a workflow template.

5. The method of claim 1 wherein determining availability of one or more resources comprises:
determining a current schedule of the one or more resources.

6. The method of claim 1 wherein scheduling the one or more orders order based on the scheduling constraints and the availability of the one or more resources comprises:
determining a schedule for the orders and the resources using a backtracking search algorithm.

7. The method of claim 1 further comprising:
reserving the resources based on the scheduled orders; and
generating schedules for each of the orders and the resources.

8. The method of claim 1 wherein scheduling the one or more orders based on the scheduling constraints and the availability of the one or more resources comprises:
determining multiple possible schedules; and
ranking one or more parameters of the schedules.

9. A scheduling system comprising:
an order input interface;
a knowledge base;
a resource manager; and
a scheduler configured to receive one or more orders from the order input interface, receive information from the knowledge base and the resource manager, and generate a schedule for the one or more orders based on the information received from the knowledge base and the resource manager.

10. The scheduling system of claim 9 wherein the order input interface comprises a memory configured to store orders.

11. The scheduling system of claim 9 wherein the knowledge base comprises at least one of a temporal constraint list, a resource constraint list, a medical constraint list, a timing list, and a workflow template.

12. The scheduling system of claim 9 wherein the resource manager comprises a schedule of one or more resources.

13. The scheduling system of claim 9 wherein the scheduler is further configured to:
reserve resources through the resource manager based on the scheduled orders; and
generate schedules for each of the orders and the resources.

14. A machine readable medium having program instructions stored thereon, the instructions capable of execution by a processor and defining the steps of:
receiving one or more orders;
determining scheduling constraints for fulfilling the orders;
determining availability of one or more resources for fulfilling the orders;
scheduling the one or more orders based on the scheduling constraints and the availability of the one or more resources.

15. The machine readable medium of claim 14, wherein the instructions further define the step of:
retrieving the orders from a memory.

16. The machine readable medium of claim 14, wherein the instructions further define the step of:
retrieving information from a knowledge base.

17. The machine readable medium of claim 14, wherein the knowledge base comprises at least one of a temporal constraint list, a resource constraint list, a medical constraint list, a timing list, and a workflow template.

18. The machine readable medium of claim 14, wherein the instructions further define the step of:
determining a current schedule of the one or more resources.

19. The machine readable medium of claim 14, wherein the instructions further define the step of:
determining a schedule for the orders and the resources using a backtracking search algorithm.

20. The machine readable medium of claim 14, wherein the instructions further define the step of:
reserving the resources based on the scheduled orders; and
generating schedules for each of the orders and the resources.

21. The machine readable medium of claim 14, wherein the instructions further define the step of:
determining multiple possible schedules; and
ranking one or more parameters of the schedules.
